(19) United States
(12) Patent Application Publication
(10) Pub. No.: US 2012/0025123 A1
(43) Pub. Date: Feb. 2, 2012

(54) High Capacity Air Admittance Valve for Sanitary Waste Pipe System

(75) Inventors: Kurt Sture Birger Ericson, Schilde (BE); Han Sin Low, Sungei Buloh (MY); Leong Ky, Petaling Jaya (MY)

(73) Assignee: Studor S.A., Luxembourg (LU)

(21) Appl. No.: 13/262,908

(22) PCT Filed: Mar. 29, 2010
(86) PCT No.: PCT/BE2010/000027

§ 371 Date: Oct. 4, 2011

(30) Foreign Application Priority Data
Apr. 6, 2009 (EP) 09 447 006.9

(51) Int. Cl. F16K 51/00

(52) U.S. Cl. 251/359

(57) ABSTRACT

The valve is designed to be connected to a sanitary waste pipe system for admitting atomospheric air into the waste pipe towards the valve function elements in response to a pressure reduction in the system in order to protect the water traps in the system and to prevent discharge of contaminated air from the system to the atmosphere. It includes an oblong bowl-shaped valve housing (10), a vertical tubular member (12) extending downwards from the housing (10) and adapted to be connected to the waste pipe system, an inner space (18) within the valve housing (10) and containing the valve function elements (34), at least one passage (26) from the valve function elements (22) towards the surrounding atmosphere and a cover member (14) overlying the inner space and having a top wall spaced above the valve function elements (20, 22, 34). The valve housing (10) is provided with at least two valve function elements (20, 22, 34) each having a circular valve seat (20) extending downwards in order to create a tubular space (22) within and connected to the valve housing (10), and a movable valve member (34) having a bowl shaped central portion (36) and a peripheral conical edge (38) extending upwardly, the outer surface of which is resting on the circular valve seat (20) in closed condition.

### FIELD OF THE INVENTION

This invention relates to a high capacity air admittance valve to be connected to a sanitary waste pipe system in order to protect the water traps in the system and to prevent communication between waste pipes or sewers systems with surrounding atmosphere, said valve opens automatically to admit outside atmospheric air into the pipe system upon presence of a pressure drop within said pipe system.

A building drainage and vent system involves, in normal operating conditions, the establishment of an induced air flow within the vertical stacks of the system due to the unsteady water downfall generated by any appliance discharge. In order to protect the habitable space against contaminated odours, each appliance is normally protected by a water trap seal. Variation due to water downfall within the drainage system, generates occasional variations in air pressure that are often capable of disturbing these water trap seals either by siphonage due to a sudden under-pressure in the system or as a result of back pressures following air path closures by water surcharge.

### DESCRIPTION OF THE PRIOR ART

Several air admittance valves have already been proposed to avoid said inconveniences and also offers the possibility of avoiding the necessity to vent the waste pipe system outside the roof of the building as said valves only open in response to sub-atmospheric pressure conditions in the waste pipe system.

Preferably, said valves are designed to assure a maximum possible air inlet flow from the air inlet of the valve to the waste pipe system while passing through the temporary opened valve membrane.

The patent document U.S. Pat. No. 4,232,706, in the name of the applicant, discloses an automatic valve device in which a vertical tube, constituting the body of the valve, comprises at its upper end a constriction in the form of a Venturi which co-operates with a cover so as to form a peripheral air inlet provided with an annular valve member situated at the exterior of the constriction and which can be tilted when a negative pressure occurs in the pipes while permitting the fresh air to penetrate into the vertical waste water pipe and which, when the pressure is equilibrated or when there is overpressure, occupies a closed position in which the escape of contaminated air is prevented.

Said valve comprises an annular peripheral opening which distributes the air inlet, in case of lifting of the annular valve member, towards the vertical tube in connection with the waste pipe. Although this device gives generally very good results with an increased air inlet capacity due to the venturi shaped tube, it may happen, in heavy duty circumstances that some turbulence may occur between the annular air inlet opening and the passage to the waste pipe. Said turbulence may occur when all of the air flow coming from the outer diameter of the annular valve member, in lifted position, is forced to be concentrated into a central tube portion of the pipe system having a smaller diameter and generally a smaller section than the overall annular valve section and will reduce, in some extend, the air inlet capacity.

In valves of this kind, the circular or annular valve member is generally resting on two concentric valve seats having each a circular sealing surface. In case of deformation or distortion of the valve member, problems could occur with the necessary airtight closure of said valve member with at least one of the two sealing surfaces.

Document U.S. Pat. No. 6,532,988 discloses a valve having a valve body with at least two air inlet openings in communication with the atmospheric air, each of the opening alternating with a passage toward the waste water pipe system; the openings and passages being equally distributed within the valve housing viewed in horizontal cross-section about the valve seat level. In normal position, the valve member is resting on a valve seat separating the openings from the passages. Said valve member having a substantially butterfly shaped sealing surface for a valve embodiment having two diametrically opposed air openings situated perpendicular respectively to two diametrically opposed air passages. The particular shape of the air distribution within the valve provides a maximum and well equilibrated air inlet and venting of the sewage system, however the manufacture of the housing and butterfly shaped valve member is rather difficult and costly. Moreover, a perfect horizontal level of the valve member and the valve seat, having a complicated peripheral circumference, is not always achieved with moulded plastic elements causing possible tightness problems of the valve.

### SUMMARY OF THE INVENTION

The main object of the present invention is to solve the above mentioned drawbacks by providing automatic air admittance valves with easy to manufacture valve closing members and corresponding valve seats, whereby the air flow capacity remains equal or is even increased for a valve having substantially the same outer dimensions.

The above objects are achieved in accordance with the technical features of the present invention which are described more particularly in the annexed set of claims.

The characteristics, advantages and features of the invention will appear from the following description of an embodiment of the valve according to the invention and in which reference is made to drawings in which:

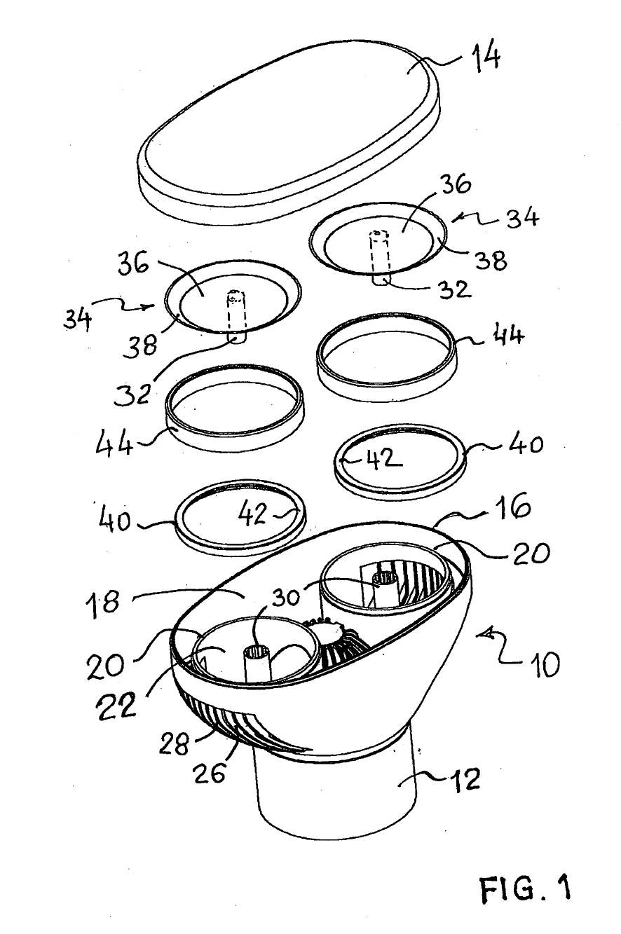

FIG. 1: is an exploded view of a valve according to the invention, showing the main components;

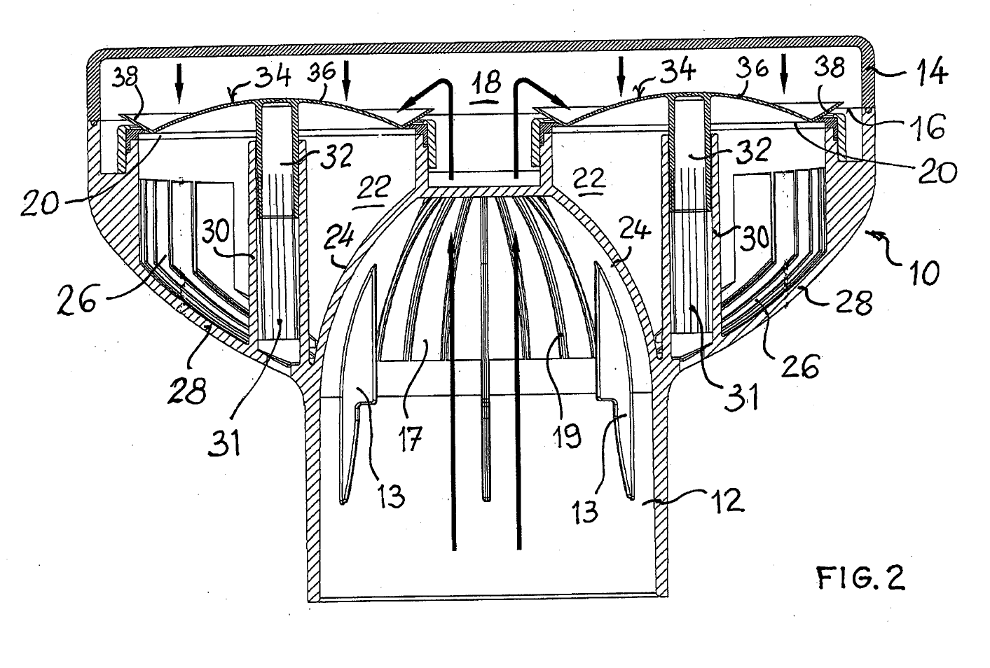

FIG. 2: is a detailed sectional view along a vertical, longitudinal central plane of the valve in normal closed position;

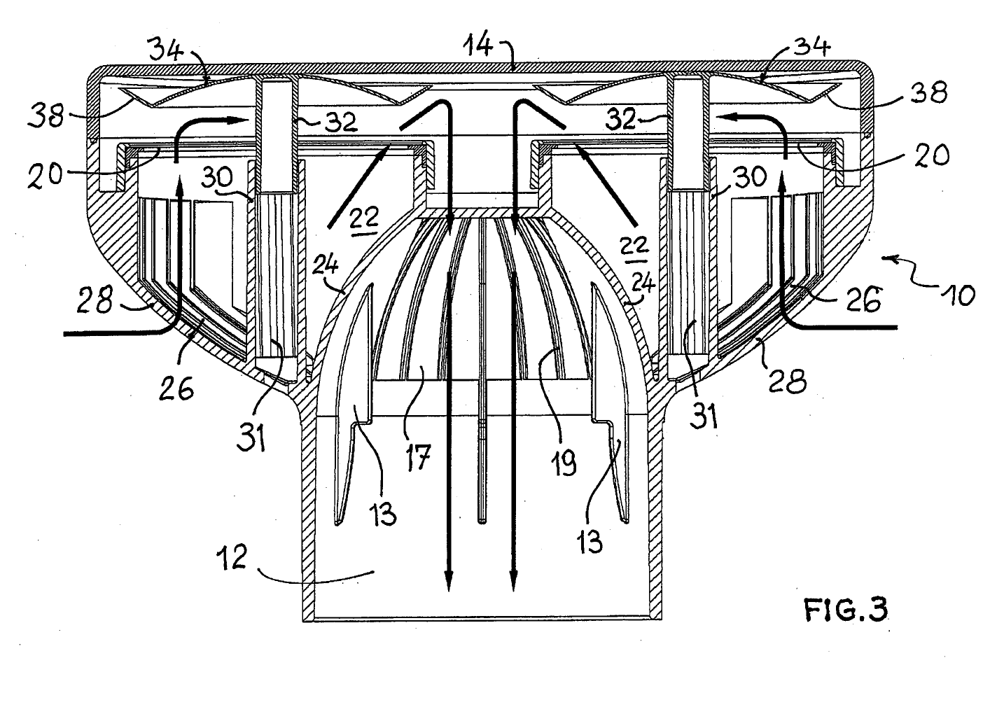

FIG. 3: is a detailed sectional view along a vertical, longitudinal central plane of the valve in open position;

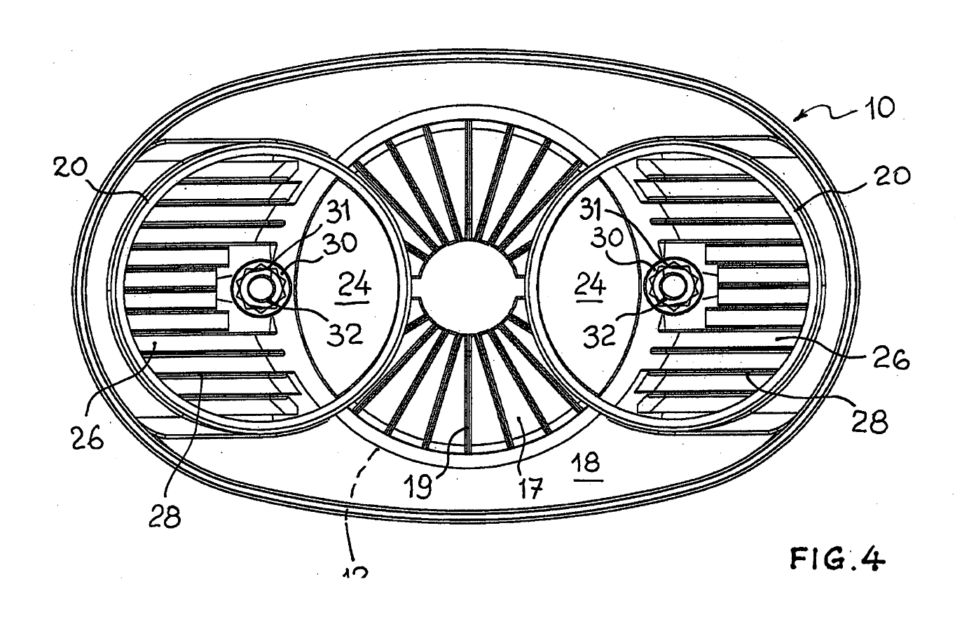

FIG. 4: is a view from above of the valve housing taken without the cover and without the closing valve members.

### DESCRIPTION OF THE PREFERRED EMBODIMENTS

As shown in FIGS. 1 to 4, the air admittance valve, according to the present invention, comprises a body having an oblong bowl-shaped valve housing 10 and a lower portion comprising a vertical tubular member 12 extending downwards and adapted to be connected to a pipe (not shown) being part of a sanitary waste water pipe system. Usually the inner part of the tubular member 12 is provided with guiding members 13 designed for connecting pipes having different diameters.

The valve housing 10 is closed at its upper portion or upper end by means of an oblong shaped cover 14 (seen from above).

The central portion 16 of the housing 10, situated between the cover 14 and the tubular member 12, contains an inner space 18 in which are usually located the valve function elements, such as the valve seat and the movable valve member. Said inner space 18 is open towards the tubular member 12 (and the waste pipe system) by means of apertures 17 separated by internal grids 19 to avoid intrusion of undesired elements or insects into the valve housing 10.

According to the invention, the inner space 18 of the central portion 16 of the valve housing 10 is provided with two circular valve seats 20 symmetrically arranged with respect to the centre of the oblong shaped upper portion of the housing.

The circular valve seats 20 extend downwards in order to create tubular spaces 22 connected to the valve housing 10 at their respective lower ends. A portion of the tubular space 22, located just above the lower tubular member 12, is closed off by means of conical walls 24 connected to the upper part of the tubular member 12.

The remaining surface of the lower extremity of the tubular spaces 22 is provided with apertures 26 open to the surrounding atmosphere. Said apertures 26 are advantageously separated with external grids 28 in order to avoid intrusion of undesired objects or insects.

The centre of each tubular space 22 is provided with a tubular guide 30 extending upwardly from the valve housing 10 and which is designed to co-operate with a movable closing valve member.

Said valve member 34 is preferably a poppet kind member 34 having a bowl shaped central portion 36 and a peripheral conical edge 38 extending upwardly. The centre of the bowl shaped portion 36 is provided at its lower side with a stem 32 extending downwards in order to co-operate with the tubular guide 30 provided within the tubular space 22.

Such kind of poppet valve member and corresponding seat structure, which are particularly suitable for this kind of application, have been disclosed and claimed in European Patent Application No. 09 447 002 in the name of the applicant.

Accordingly, the circular valve seats 20, co-operating with such movable valve members 34 are advantageously provided with a soft annular ring 40 having an inner cantilever lip 42. Said soft annular ring 40 being clamped on the valve seat 20 of the housing 10 by means of an annular ring 44.

The FIG. 2 shows the air admittance valve, according to the invention, in normal closed position whereby the air pressure contained within the sewage pipe system is generally equal or superior to the atmospheric pressure outside the system. In this position, the peripheral conical edge 38 of the valve member 34 is resting onto the inner cantilever lip 42 of the soft annular ring 40 positioned onto the circular seat 20. The higher the air pressure inside the waste water pipe system will raise, the firmer the valve member 34 will be pressed against the cantilever lip 42 increasing and securing at the same time the tightness of the valve function.

In case the air pressure within the sewage pipe system drops suddenly below the atmospheric pressure, the valve members 34, having their lower surface in communication with the atmospheric air pressure and their upper surface in communication with the air inside the sewage pipe system, will promptly be tilted upwards (FIG. 3).

This will allow the atmospheric air to enter promptly through the apertures 26 into the tubular spaces 22 and both peripheral gaps, now created between the respective valve seats 20 and the peripheral conical edge 38 of the valve members 34. Said incoming air flow will be sucked downwards passing through the apertures 17 towards the inner space of the lower tubular member 12 and into the waste water pipe system. Such incoming air flow will balance the air pressure inside the system and avoid sucking out the several water traps contained in the sanitary waste water piping.

The upwards movement of the valve members 34 will be limited by the central bowl shaped portion 36 of the valve members which will contact the lower surface of the cover 14 of the valve housing 10. This will avoid the stems 32 to loose contact with their respective guiding means 30 of the valve housing 10.

In order to reduce the friction between the stems 32 and the guiding means 30, the inner surface of these portions will be provided with longitudinal ribs 31.

The FIG. 4 shows the various inner spaces, seen from above, of the air admittance valve according to the invention. It clearly shows the outer oblong (cross sectional) shape of the valve housing 10 and the location of the two circular valve seats 20.

The circular valve seats 20 are extending downwards forming tubular spaces 22 which are closed off, on the one hand, from the tubular member 12 by means of the conical walls 24 and which are provided, on the other hand, with apertures 26 open towards the surrounding atmosphere and external grids 28 to avoid undesired objects or insects to enter into the valve. The centre of the tubular spaces 22 are provided with tubular guides 30 extending upwards in order to co-operate with stems 32 extending downwards from the closing valve member 34.

The centre of the inner space 18 between the two tubular spaces 22, is open towards the tubular member 12 and consequently towards the sanitary waste pipe system by means of apertures 17 separated by internal grids 19, part of the valve housing 10.

Tests have shown that the air flow capacity of the valve according to the present invention has significantly improved with respect to the existing air admittance valves.

The purpose of the embodiments as described herewith is only to illustrate the invention while still other variations are possible without falling out of the scope of the invention as expressed in the following claims. Consequently, it would be possible, for example, that the circular valve seats extending downwards and creating two tubular spaces and which have been illustrated as being of the same diameter, could have different diameters so as to allow each of the valve function elements to accommodate their successive or simultaneous opening according to the need of air inflow trough only one or both of the valve functions.

### LEGEND OF THE REFERENCE NUMERALS

10: valve housing

12: tubular member

13: internal guiding means of the tubular member 12

14: cover of the valve housing

16: central part of the housing

17: apertures towards tubular member 12

18: inner space

19: internal grids

20: circular valve seat

22: tubular space

24: conical wall

26: apertures open to atmospheric air

28: external grids

30: guiding means

31: longitudinal ribs

32: stem of valve member

34: valve member

36: bowl shaped central portion

38: peripheral conical edge of valve member

40: soft annular ring

42: cantilever lip

44: annular ring

1. An air admittance valve to be connected to a sanitary waste pipe system for admitting atmospheric air into the waste pipe towards valve function elements in response to a pressure reduction in the system in order to protect water traps in the system and to prevent discharge of contaminated air from the system to the atmosphere, the air admittance valve comprising:
an oblong bowl-shaped valve housing;
a vertical tubular member extending downwards from the housing and adapted to be connected to the waste pipe system;
an inner space within the valve housing and containing the valve function elements;
at least one passage from the inner space of the tubular member towards the valve function elements;
at least one passage from the valve function elements towards the surrounding atmosphere;
a cover member overlying said inner space having a top wall positioned at a distance above the valve function elements;
wherein the valve housing includes at least two valve function elements each comprising circular valve seat extending downwards in order to create a tubular space within and connected to the valve housing and a movable valve member having a bowl shaped central portion and a peripheral conical edge extending upwardly, the outer surface of which is resting on the circular valve seat in a closed condition.

2. An air admittance valve, according to claim 1, wherein the inner portion of the valve housing is provided with two circular valve seats symmetrically arranged with respect to a center of the oblong shaped housing.

3. An air admittance valve, according to claim 1, wherein the tubular space created by each of the at least two valve function elements has a lower part, and wherein the lower part of the tubular spaces, located above the lower tubular member, is closed off by means of conical walls connected to the upper part of the tubular member.

4. An air admittance valve according to claim 3, wherein the tubular spaces further include a lower extremity having a remaining surface, and wherein the remaining surface of the lower extremity of the tubular spaces is provided with apertures open to the surrounding atmosphere, said apertures being separated with external grids in order to avoid intrusion of undesired objects or insects.

5. An air admittance valve, according to claim 1, wherein a center of each tubular space is provided with a tubular guide member extending upwardly from the valve housing and which is designed to co-operate with a stem extending downwards from a center of the lower part of the bowl shaped portion of the valve member.

6. An air admittance valve, according to claim 1, wherein the circular valve seats are provided with a soft annular ring having an inner cantilever lip.

7. An air admittance valve, according to claim 6, wherein the soft annular ring is clamped onto the circular valve seat of the valve housing by means of an annular ring.

8. An air admittance valve, according to claim 1, wherein the inner space of the valve housing is open towards the tubular member by means of apertures separated by internal grids to avoid intrusion of undesired objects or insects into the valve housing.

9. An air admittance valve according to claim 5, wherein the tubular guide members are provided along their respective inner surfaces with longitudinal ribs in order to reduce the friction between the stem of the movable valve member and the inner surface of the tubular guide members.
